(19) United States
(12) Patent Application Publication
(10) Pub. No.: US 2023/0118441 A1
(43) Pub. Date: Apr. 20, 2023

(54) APPARATUS AND METHOD TO ENABLE A CENTRAL FOCAL POINT ON AN IMAGE SENSOR VIA A PAN, TILT AND ZOOM CAMERA

(71) Applicant: Dell Products L.P., Round Rock, TX (US)

(72) Inventors: Chih-Hao Kao, Luzhou District (TW); Ghee Beng Ooi, Singapore (SG); Lai Say Poh, Singapore (SG)

(73) Assignee: Dell Products L.P., Round Rock, TX (US)

(21) Appl. No.: 17/505,980

(22) Filed: Oct. 20, 2021

(51) Int. Cl. H04N 5/232; H04N 5/225; G06F 1/16

(52) U.S. Cl. CPC H04N 5/23299; H04N 5/2254; H04N 5/2257; H04N 5/23296; G06F 1/1605

(57) ABSTRACT

An information handling system display includes a camera having a cylindrical housing and an extension housing, the extension housing extending and retracting from the cylindrical housing along an extension axis and including a prism assembly, an image sensor and a telescopic lens disposed between the image sensor and prism assembly. The prism assembly tilts vertically relative to the extension housing to adjust a tilt axis of light that passes to the image sensor and rotates with the extension housing relative to the cylindrical housing to adjust pan of the light that passes to the image sensor. In one alternative embodiment, the camera has a stand-alone configuration that interfaces with the information handling system as a peripheral device resting on a desktop surface or coupled to a display.

### BACKGROUND OF THE INVENTION

### Field of the Invention

The present invention relates in general to the field of information handling system integrated cameras, and more particularly to an information handling system display monitor having an apparatus and method to enable a central focal point on an image sensor via a pan, tilt and zoom camera.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware, and software components that may be configured to process, store, and communicate information and may include one or more computer systems, data storage systems, and networking systems.

Generally, information handling systems are configured as stationary and portable systems. Stationary information handling systems, such as desktops, towers and servers, have housings designed to operate in a fixed location, typically with peripheral input/output devices. Portable information handling systems integrate processing components, a display and a power source in a portable housing to support mobile operations. Portable information handling systems come in a variety of form factors. Tablet configurations typically expose a touchscreen display on a planar housing that both outputs information as visual images and accepts inputs as touches. Larger tablets are sometimes coupled to a display stand and used as an all-in-one desktop systems supported by a peripheral keyboard. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell position, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility. Although portable information handling systems typically integrate a display, end users often interface with peripheral displays to increase the viewing area supported by the system.

One common peripheral used with information handling systems is a camera, such as to support videoconferencing. Typically, peripheral cameras couple with a clip or bracket to a top side of a peripheral display so that an end user viewing the display will appear to be looking at the camera. Some displays integrate cameras in the display housing, including portable information handling systems, which often integrate a display to capture visual images through an opening in the housing bezel. One difficulty with integration of a camera in a display is that the display typically has a thin housing that lacks sufficient room for a high quality camera or to support tilt, and pan of the camera field of view. As a result, end users tend to have to center their face in a certain area during a videoconference so that the camera can capture a reasonable visual image. Some stands and portable information handling systems allow changes in the rotational orientation of the display that support some tilt of a fixed camera, however, tilting the entire display to adjust the camera field of view can degrade the image quality presented at the display. Further, the thin profile of typical display housings prevents movement of the camera lens, such as to support zoom with a telescopic lens.

In some instances, cameras integrated in a display monitor or information handling system housing use auto framing to highlight a limited portion of a visual image captured in a large field of view. By including a lens with a wide field of view, such as a fish eye lens, partial areas of the captured visual image may be used, such as just the portion that includes an end user. Auto framing involves a digital zoom in which a cropped portion is digitally scaled up to the dimension of the original image. Auto framing and digital zoom each introduce distortions and reduced image quality that impacts the image presented by the camera. For example, auto framing with a part of the visual image capture along the edge of the lens tends to introduce distortions due to the underlying light captured at the image processor perimeter. Zooming reduces image resolution by having fewer capture pixels at the light sensor, often resulting in a grainy visual image appearance. Although these distortion and resolution issues can be managed by using optics to capture higher quality visual images, information handling system display housings typically lack space to include movable optics, such as a telescoping lens, or mechanical tilt, and pan mechanisms.

### SUMMARY OF THE INVENTION

Therefore, a need has arisen for a system and method which supports optical pan, tilt, and zoom integrated with a camera of a display.

In accordance with the present invention, a system and method are provided which substantially reduce the disadvantages and problems associated with previous methods and systems of providing optical pan, tilt, and zoom for a camera integrated with a display. An image sensor couples in an extension housing aligned to accept light reflected by a prism assembly, and/or other reflective surface from along a prism axis. Visual images captured by the image sensor are optically centered at a selected target, such as an end user participant in a video conference, by vertically tilting the prism assembly to adjust the camera field of view tilt, and by rotating an extension housing that holds the prism assembly to pan the camera field of view.

More specifically, an information handling system processes information with a processor and memory disposed in a housing and presents the information as visual images at a display, such as peripheral display separate from the information handling system or an integrated display in a portable housing. A camera integrates in the display housing to have a retracted position with the camera powered off, and an extended position with the camera powered up to capture visual images at selected pan, tilt and zoom orientations. An extension housing retracts into and extends from a cylindrical housing and includes an image sensor coupled in fixed locations relative to a prism assembly that directs light from along a prism axis to the image sensor. The camera adjusts a tilt of the camera field of view by rotating the prism assembly about a horizontal axis to vertically adjust a tilt of a prism axis that directs light to the image sensor. The camera adjusts a pan of the camera field of view by rotating the extension housing relative to the cylindrical housing. A telescopic lens assembly disposed between the prism assembly and the image sensor provides a zoom in and out of visual images reflected by the prism assembly and/or other reflective surface along the prism axis to the image sensor. Automated pan, tilt and zoom adjustments maintain a selected target at a central portion of the image sensor for improved image capture quality.

The present invention provides a number of important technical advantages. One example of an important technical advantage is that a visual image captured by a camera integrated in a display housing has optical pan, tilt and zoom so that a target of the camera remains centered in an image sensor of the camera for improved image quality, and reduced distortions associated with auto framing. A prism axis that directs light to an image sensor has a tilt adjustment by rotation of the prism assembly within an extension housing and by a separate mechanism from a pan adjustment by a rotation of the extension housing. Automated adjustments of pan and tilt by rotation of the prism mechanism and the extension housing allows a centering of the camera field of view so that zoom by a telescopic lens assembly has an undistorted visual image of a desired target, such as an end user participant of a video conference.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system interfaced with a peripheral display having a camera retracted to the display interior;

FIGS. 2 and 2A depict the peripheral display having the camera in an extended position to capture visual images;

FIGS. 3A, 3B, 3C and 3D depict a block diagram of pan, tilt, and zoom operations performed with the camera;

FIGS. 4 and 4A depict an example of adjustments to tilt field of view of the camera by rotation of the prism assembly;

FIG. 5 depicts an upper perspective transparent view of an example embodiment for rotation to achieve camera pan, and tilt;

FIG. 6 depicts a flow diagram of a process for initiating capture of visual images with the camera; and

FIG. 7 depicts a flow diagram of a process for completing capture of visual information with the camera.

### DETAILED DESCRIPTION

An information handling system display captures visual images with a camera that extends a prism assembly out from the display interior to rotate, and tilt to a desired field of view. For purposes of this disclosure, an information handling system may include any instrumentality, or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

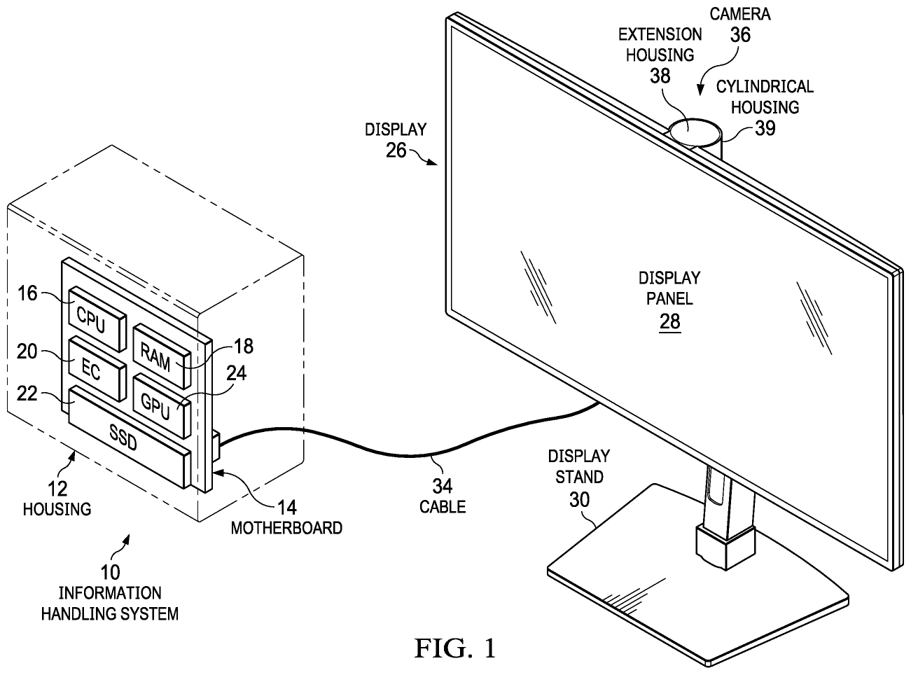

Referring now to FIG. 1, an information handling system 10 is depicted interfaced with a peripheral display 26 having a camera 36 retracted into the display interior. In the example embodiment, information handling system 10 processes information with processing components disposed in a housing 12 having a stationary configuration, such as a desktop or tower configuration, and presenting the information as visual images at peripheral display 26 in a separate housing. In alternative embodiments, housing 12 may have a portable configuration that includes display 26 integrated with it. Information handling system 10 processes information with a central processing unit (CPU) 16 coupled to a motherboard 14 to communicate with a random access memory (RAM) 18 that stores the information and instructions. An embedded controller 20 interfaces with CPU 16 to support management of operational conditions within housing 12, such as application of power, management of thermal conditions and interactions with peripheral devices. A graphics processing unit (GPU) 24 interfaces with CPU 16 to further process the information for defining visual images presented at display 26, such as by defining pixel values that define colors presented at display panel 28. A solid state drive (SSD) 22 provides persistent storage of the information and instructions, such as during power down of information handling system 10.

During normal operations, information handling system 10 processes information by executing an operating system that supports a video conferencing application. Incoming video is processed by CPU 16 and provided to GPU 24 to present as visual images at display panel 28 through a display cable 34. Display 26 holds display panel 28 in a viewing position raised by a display stand 30 that rests on a support surface. If the end user desires to participate in the video conference by sending visual images of himself as he views display panel 28, the end user activates a camera 36 that captures visual images of a field of view in front of display panel 28 and sends the captured visual images through cable 34 to information handling system 10 for communication as part of the video conference. In addition, camera 36 visual images may be presented at display panel 28 to show the end user how the end user appears to other participants of the video conference. In order to activate camera 36, the end user raises an extension housing 38 out of a cylindrical housing 39 to allow exterior light to reach an image sensor located in the interior of display 26. In the example embodiment, cylindrical housing 39 integrates as part of the back cover of display stand 30. In alternative embodiments, cylindrical housing 39 may couple within the interior of display 26 and be covered by the back side of display stand 30.

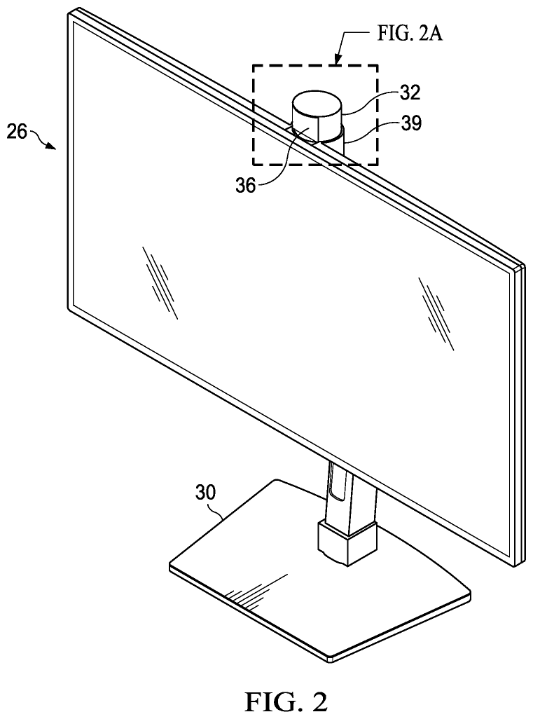

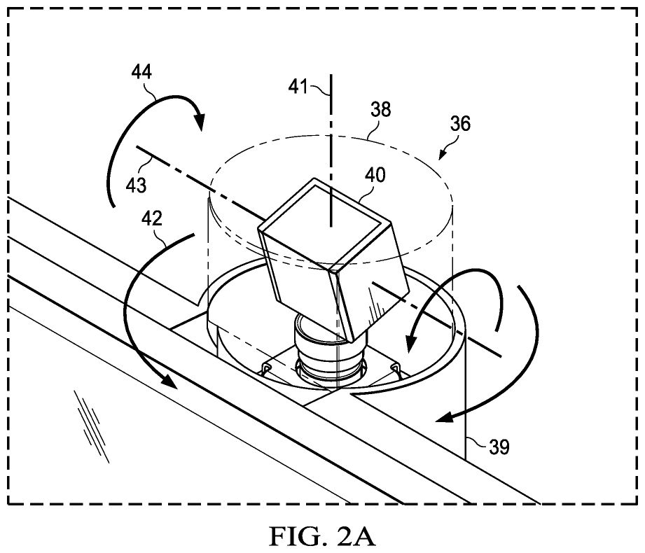

Referring now to FIGS. 2 and 2A, the peripheral display 26 is depicted having the camera 36 in an extended position to capture visual images. Extension housing 32 extends out of cylindrical housing 39 to expose a window of extension housing 32 that allows external light to pass through to an image sensor for capture of visual images. In the example embodiment, a prism assembly 40 resides within extension housing 38. The prism assembly includes a prism that accepts light along a first axis and refracts the light to a second axis that aligns with an image sensor to capture a visual image of the light from the first axis. In some embodiments, a prism may include a reflective surface, such as a mirror, that reflects light from the front of display 26 into an image sensor disposed in the interior of camera 36, such as a reflective coating at one side of the prism material. The prism and/or reflective surfaces may cooperate to direct light to the image sensor, or the prism assembly may include only a prism, such as a refractive crystal or similar structure. In an alternative embodiment, reflective surfaces, such as mirrors may be used to redirect light to the image sensor without a prism. Prism assembly 40 supports tilt, and pan of the visual images captured by the image sensor by moving relative to display 26. For example, extension housing 38 extends from cylindrical housing 39 along an extension axis 41 and supports camera pan as indicated by arrow 42 with rotation of extension housing 38 within cylindrical housing 39 about extension axis 41. Prism assembly 40 maintains a rotational orientation position relative to extension housing 38 so that rotation of extension housing 38 provides rotation of prism assembly 40. Prism assembly 40 rotates about a tilt axis 43 to provide a tilt of the captured camera image as indicated by arrow 44.

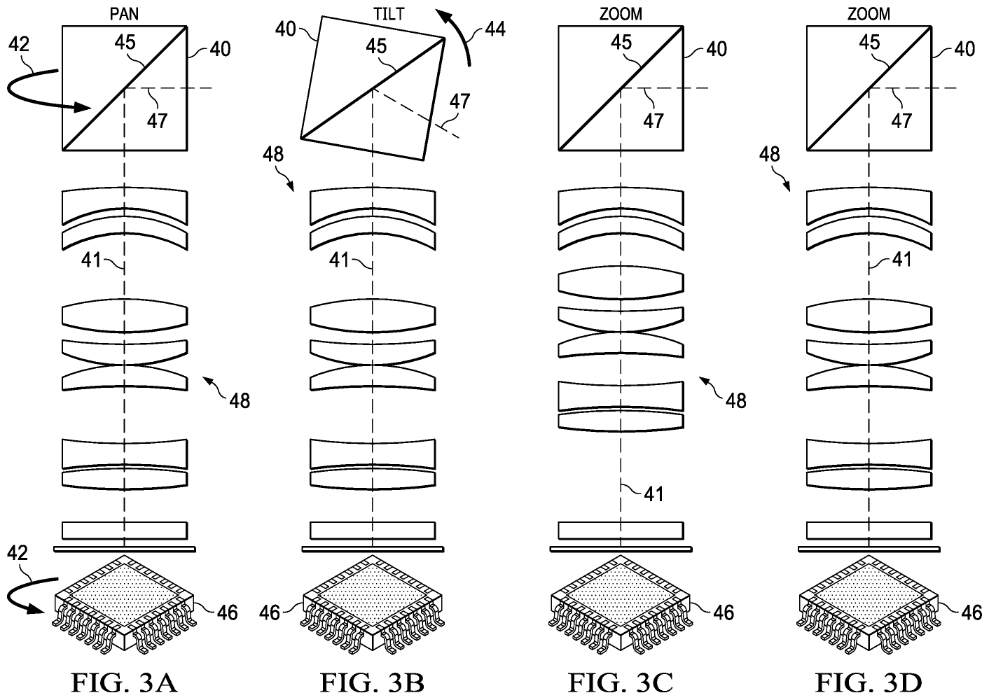

Referring now to FIGS. 3A, 3B, 3C and 3D, block diagrams depict pan, tilt and zoom operations performed with the camera. FIG. 3A depicts pan of the camera field of view by a pan rotation 42 of prism assembly 40 about extension axis 41. In the example embodiment, image sensor 46 couples in a fixed location relative to prism assembly 40, such as in a fixed location to the extension housing so that rotation of the extension housing to rotate prism assembly 40 also rotates image sensor 46. Fixing the rotational orientation of prism assembly 40 and image sensor 46 allows support of pan of the camera field of view without adjusting the image sensor captured image. FIG. 3B depicts tilt of the camera field of view by a tilt rotation 44 to change the direction of a prism axis 47 extending from a prism having a refractive and/or reflective surface, such as a mirror 45. In the example embodiment, the prism refractive and/or reflective surface, such as mirror 45, tilts so that prism axis 47 changes the orientation at which light reflects into image sensor 46. In an alternative embodiment, image sensor 46 may have a fixed orientation relative to prism axis 47 by rotating off of extension axis 41 when prism assembly 40 rotates, although such alternative embodiments would tend to increase the size of the extension housing and/or reduce the distance between the prism refractive and/or reflective surface, such as mirror 45, and image sensor 46, which might impact camera zoom. FIGS. 3C and 3D depict zoom changes of a telescopic lens assembly 48 to provide optical zoom capability by vertically changing the position of the telescopic lens assembly.

Coupling image sensor 46 aligned along extension axis 41 directly below the prism refractive and/or reflective surface, such as mirror 45, and telescope lens assembly 48 allows the entire structure to rotate about extension axis 41 to provide a pan of the camera field of view, such as by rotating the cylindrical-shaped extension housing within the cylindrical housing. This pan operation allows a capture of side to side visual images at the front side of the display while maintaining focus of light on a center of image sensor 46 so that the periphery of the light that might be distorted by the lens does not become a non-central part of the visual image as can happen with auto framing. Similarly, when image sensor 46 is fixed in position relative to the extension housing, tilt movement is achieved by rotation of prism assembly 40 relative to and within the interior of the extension housing. Tilt of prism assembly 40 changes the light direction angle provided from prism axis 47 to center a vertical field of view at image sensor 46, thereby avoiding distortions associated with auto framing of a visual image with a fixed vertical field of view. Vertical movement of the telescopic lens assembly 48 provides zoom in and zoom out of the visual image projected against image sensor 46 so that the focal point on the center of image sensor 46 is maintained. Control of the visual image focal point with optical pan, tilt and zoom of the camera eliminates distortions that need correction with post image collection processing. In alternative embodiments, optical pan, tilt, and zoom may be used to keep an optical image centered on the images sensor while the image sensor has a flexible position relative to the optics that perform pan, tilt, and zoom. For example, image sensor 46 might couple to a fixed location relative to display 26 so that rotation of the extension housing rotates the image as refracted and/or reflected from the prism assembly and reflective surface, such as a mirror. In such an embodiment, digital correction of the captured visual image provides an upright view without changing the resolution. As another example, coupling image sensor 46 to the prism assembly maintains a constant refractive and/or reflection angle while rotation of the prism assembly provides pan of the visual image.

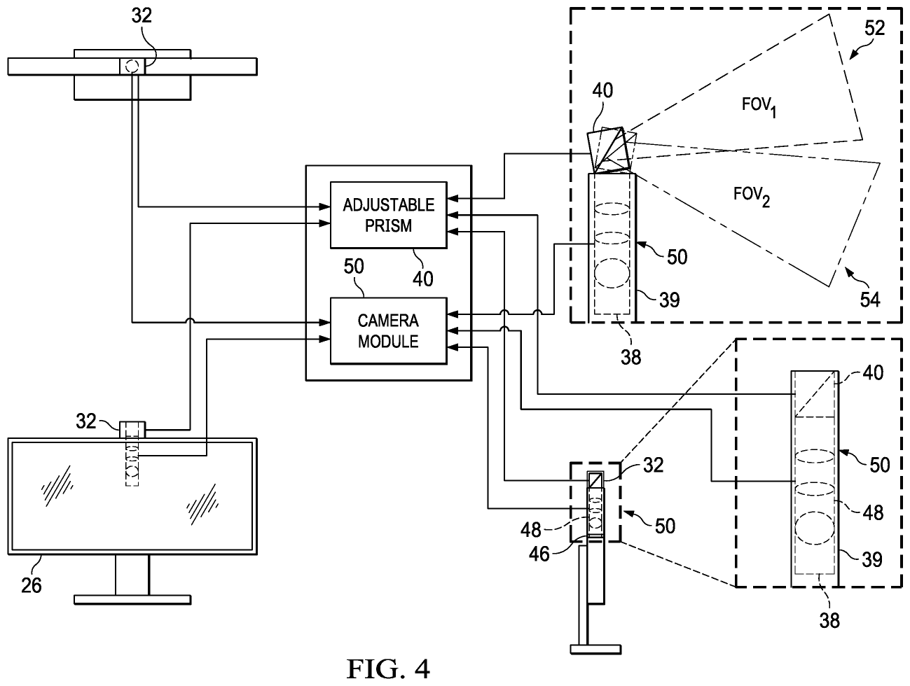

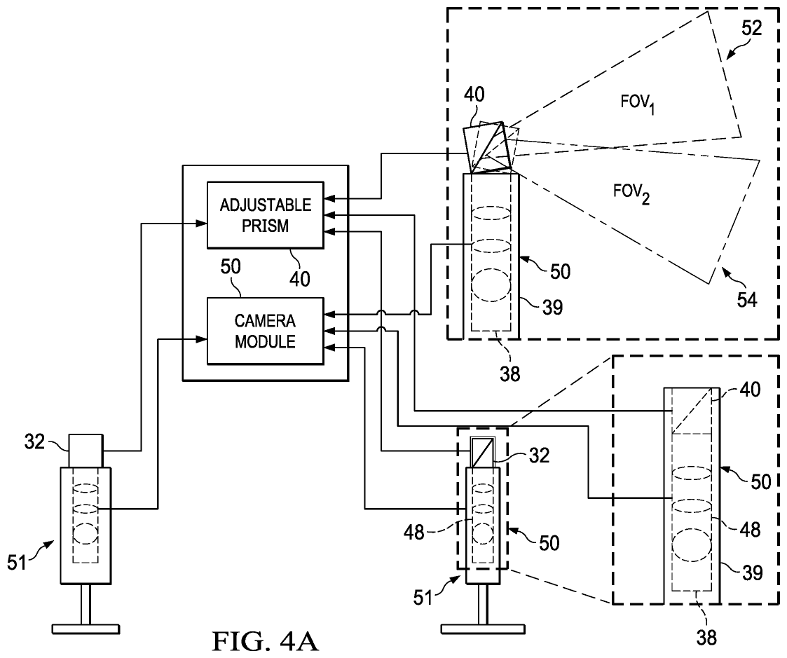

Referring now to FIG. 4, an example depicts adjustments to tilt field of view of the camera by rotation of the prism assembly. In the example embodiment, a camera module 50 is built into the interior of a display 26 to have a telescopic lens assembly 48, image sensor 46 and prism assembly 40 coupled in an extension housing 32 that extends from and retracts into a cylindrical housing 39 disposed in the interior of display 26. Prism assembly 40 tilts relative to image sensor 46 to change the field of view of light that reflects to image sensor 46. In the example embodiment, a first field of view 52 is reflected at image sensor 46 when prism assembly 40 tilts upward and a second field of view 54 is refracted and/or reflected at image sensor 46 when prism assembly 40 tilts downward. At completion of the user of camera module 50, prism assembly 40 retracts into the interior of display 26 to prevent capture of visual images, thereby offering enhanced system security.

FIG. 4A depicts an alternative embodiment in which camera module 50 is held in stand-alone housing 51 that interfaces as a peripheral device with an information handling system or display. For example, stand-alone housing 51 rests as a stand on desktop surface or couples to a display as a peripheral device that communicates captured visual images through a USB or similar cable. Camera module 50 is built into the interior of stand-alone housing 51, which can have a cylindrical or other type of shape. A telescopic lens assembly 48, image sensor 46 and prism assembly 40 couple in an extension housing 32 that extends from and retracts into cylindrical housing 39 disposed in stand-alone housing 51. Prism assembly 40 tilts relative to image sensor 46 to change the field of view of light that reflects to image sensor 46. In the example embodiment, a first field of view 52 is reflected at image sensor 46 when prism assembly 40 tilts upward and a second field of view 54 is reflected at image sensor 46 when prism assembly 40 tilts downward. At completion of the user of camera module 50, prism assembly 40 retracts into the interior of stand-alone housing 51 to prevent capture of visual images, thereby offering enhanced system security. Pan, tilt, and zoom provided by camera module 50 improves image quality captured by centering the desired field of view, such as an end user face, at an image sensor so that the full resolution of the image sensor is used to capture desired subject matter.

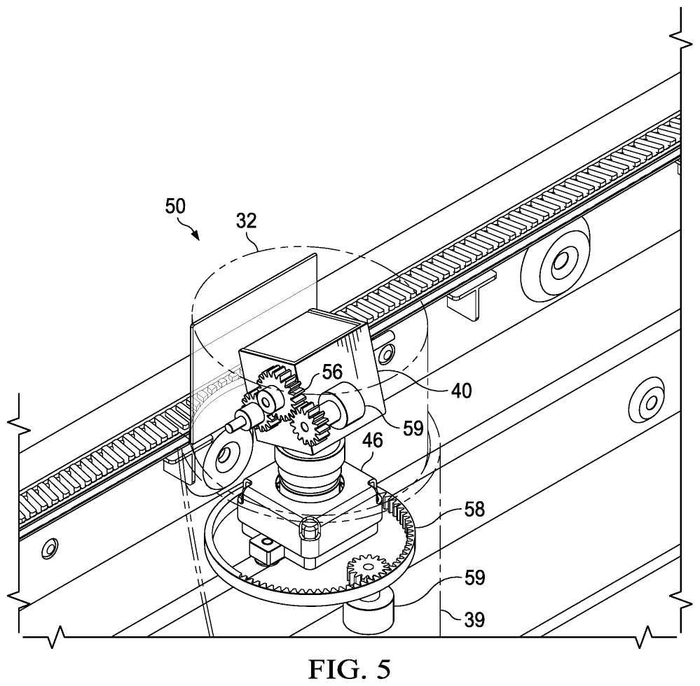

Referring now to FIG. 5, an upper perspective transparent view depicts an example embodiment for rotation to achieve camera pan and tilt. In the example embodiment, prism assembly 40 has tilt adjustment provided by a set of tilt gears 56 driven by a first step motor 59, such as a step motor that interfaces with the embedded controller to move prism assembly 40 to a selected tilt orientation. Tilt gears 56 are hidden within extension housing 32 to provide an aesthetically pleasing solution with a rapid and accurate tilt selection adjustment. Pan of camera module 50 is managed with rotation of extension housing 32 relative to the cylindrical housing 39 by a ring gear 58 coupled to the inner circumference of extension housing 32 and interfaced with a second step motor 59 coupled to cylindrical housing 39. Actuation of the second step motor 59 causes rotation of extension housing 32 relative to cylindrical housing 39 to provide a pan of the camera field of view by rotating the prism axis of prism assembly 40 about the extension axis. Tilt and pan may be provided in response to an end user selection, such as through a user interface, or with automated analysis of visual images captured by camera module 50 with firmware stored in non-transitory memory and executed on a controller. For instance, visual images sensed by image sensor 46 are analyzed at the embedded controller to center the camera tilt field of view on a face detected in the sensed image. Alternatively, automated adjustments to the camera field of view may be provided by a controller include in camera module 50 so that an end user captured in a visual image remains centered in the camera field of view. In addition to the centering of the field of view, automated image analysis may provide zoom to maintain the end user as a predetermined portion to the field of view captured by camera module 50. Optical pan, tilt and zoom of the visual image captured by image sensor 46 improves image quality by centering the captured image in an area where less distortion is present and by using the full resolution of image sensor 46. Although the example embodiment provides tilt and pan adjustment with motors 59 in fixed locations at extension housing 32 and cylindrical housing, in alternative embodiments the motors 59 may affix to prism assembly 40 and extension housing 32 to work against opposing gears in extension housing 32 and cylindrical housing 39 respectively.

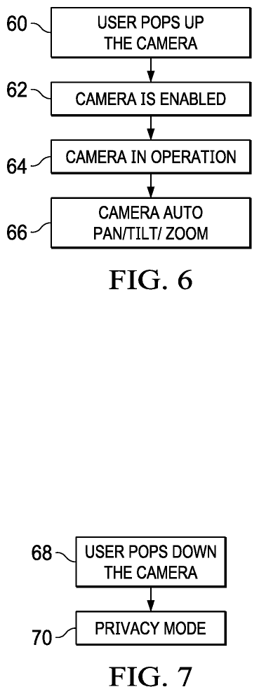

Referring now to FIG. 6, a flow diagram depicts a process for initiating capture of visual images with the camera. At step 60 the end user pops up the camera to extend the extension housing upward and out of the display interior, such as by sliding upwards and out of the cylindrical housing. At step 62, power is applied to the camera at the extension to enable the capture of visual images. At step 64 the camera operates to capture visual images of an end user in a field of view adjusted by vertically tilting a prism axis of a prism assembly coupled within the extension housing, rotating the prism axis with rotation of the extension housing relative to the display and zooming with a telescopic lens assembly disposed between the prism assembly and image sensor. Centering the captured visual image on an end user provides excellent captured image quality without introduction of distortions that can occur without auto framing. At step 66 the camera automatically adjusts pan, tilt and zoom to keep the end user centered as the end user moves relative to the display.

Referring now to FIG. 7, a flow diagram depicts a process for completing capture of visual information with the camera. At step 68 the end user pops down the camera by retracting the extension housing into the camera interior, such as sliding the extension housing into the cylindrical housing. Retracting the extension housing into the display blocks light entry to the prism and thus provides physical security against unauthorized capture of visual images, such as by a malicious hacker. At step 70 the camera enters a privacy mode, such as by powering down the image sensor.

Although the present invention has been described in detail, it should be understood that various changes, substitutions and alterations can be made hereto without departing from the spirit and scope of the invention as defined by the appended claims.

1. An information handling system comprising:
a housing;
a processor disposed in the housing and operable to execute instructions;
a memory disposed in the housing and interfaced with the processor, the memory operable to store the instructions and information;
a display interfaced with the processor and operable to present the information as visual images, the display having an interior; and
a camera coupled to the display, the camera having a cylindrical housing, an extension housing that retracts into and extends out of the cylindrical housing along an extension axis, a prism assembly disposed in the extension housing and an image sensor disposed in the extension housing, the prism assembly including a refractive material that captures light along a prism axis and direct the light at the image sensor, the prism assembly rotating relative to the extension housing to vertically adjust the prism axis and thereby tilt of the camera.

2. The information handling system of claim 1 further comprising:
a telescopic lens assembly disposed between the prism assembly and the image sensor;
wherein the telescopic lens assembly adjusts vertically along the extension axis to adjust zoom of the camera.

3. The information handling system of claim 2 wherein the extension housing rotates relative to the cylindrical housing to rotate the prism axis about the extension axis.

4. The information handling system of claim 3 wherein the image sensor couples in a fixed orientation relative to the extension housing.

5. The information handling system of claim 4 further comprising:
a ring gear coupled to the extension housing; and
a motor coupled to the cylindrical housing and having a gear engaged with the ring gear to rotate the extension housing.

6. The information handling system of claim 4 further comprising:
a ring gear coupled to the cylindrical housing; and
a motor coupled to the extension housing and having a gear engaged with the ring gear to rotate the extension housing.

7. The information handling system of claim 4 further comprising:
a first motor coupled between the prism assembly and the extension housing and operable to actuate to rotate the prism assembly to change the tilt of the prism axis; and
a controller interfaced with the processor and the first motor to command the first motor to a predetermined tilt.

8. The information handling system of claim 7 further comprising:
a second motor coupled between the extension housing and the cylindrical housing and operable to actuate to rotate the extension housing relative to the cylindrical housing; and
a controller interfaced with the processor and the second motor to command the motor to a predetermined rotational orientation.

9. The information handling system of claim 8 further comprising a non-transitory memory storing instructions that when executed on the controller:
commands the first motor to center tilt on a target;
commands the second motor to center pan on the target; and
commands a telescopic zoom with the telescopic lens to capture the target in predetermined portions of the image sensor.

10. A method for capturing visual images at a display, the method comprising:
extending a first housing from within a second housing along an extension axis, the second housing coupled within the display interior;
rotating the first housing relative to the second housing about the extension axis to direct a prism axis of a prism assembly coupled in an interior of the first housing to a predetermined pan field of view, the prism assembly having a refractive material that refracts light from the prism axis to the extension axis; and
capturing visual images with an image sensor aligned to receive light refracted from the prism assembly along the prism axis.

11. The method of claim 10 further comprising:
tilting the prism assembly within the first housing to align the prism axis with a predetermined tilt field of view; and
rotating the prism assembly with the rotating the first housing.

12. The method of claim 11 further comprising:
coupling the image sensor to the first housing aligned to receive light reflected from the prism assembly;
rotating the image sensor with the rotating the first housing; and
maintaining the image sensor orientation relative to the prism assembly during the tilting.

13. The method of claim 11 further comprising:
coupling the image sensor to the prism assembly; and
rotating the image sensor with the rotating the first housing; and
tilting the image sensor orientation with the tilting the prism assembly.

14. The method of claim 11 further comprising:
coupling the image sensor to the second housing; and
correcting orientation of visual images captured by the image sensor based upon the amount of the rotating and the tilting.

15. The method of claim 11 further comprising:
coupling a telescopic lens assembly between the image sensor and the prism assembly; and
adjusting the telescopic lens assembly to adjust a zoom of the visual image captured by the image sensor.

16. A camera comprising:
a cylindrical housing;
an extension housing that retracts into and extends out of the cylindrical housing along an extension axis;
a prism assembly disposed in the extension housing and having a refractive material aligned to capture light along a prism axis; and
an image sensor disposed in the extension housing at a fixed orientation relative to the extension housing, the prism assembly refracting the light from the prism axis to direct the light at the image sensor, the prism assembly rotating relative to the extension housing to vertically adjust the prism axis and thereby tilt of the camera, the extension housing rotating relative to the cylindrical housing to rotate the prism axis about the extension axis.

17. The camera of claim 16 further comprising:
a telescopic lens assembly disposed between the prism assembly and the image sensor;
wherein the telescopic lens assembly adjusts vertically along the extension axis to adjust zoom of the camera.

18. The camera of claim 17 further comprising:
a ring gear coupled to the extension housing; and
a motor coupled to the cylindrical housing and having a gear engaged with the ring gear to rotate the extension housing.

19. The camera of claim 18 further comprising:
a first motor coupled between the prism assembly and the extension housing and operable to actuate to rotate the prism assembly to change the tilt of the prism axis; and
a controller interfaced with the processor and the first motor to command the first motor to a predetermined tilt.

20. The camera of claim 19 further comprising:
a second motor coupled between the extension housing and the cylindrical housing and operable to actuate to rotate the extension housing relative to the cylindrical housing; and
a controller interfaced with the processor and the second motor to command the motor to a predetermined rotational orientation.
